(19) United States
(12) Patent Application Publication
(10) Pub. No.: US 2018/0103608 A1
(43) Pub. Date: Apr. 19, 2018

(54) DOG KENNEL MAT

(71) Applicant: Dry Dog LLC, Edina, MN (US)

(72) Inventor: Benjamin A. Bohline, Edina, MN (US)

(21) Appl. No.: 15/786,338

(22) Filed: Oct. 17, 2017

Related U.S. Application Data
(63) Continuation-in-part of application No. 29/599,290, filed on Mar. 31, 2017.
(60) Provisional application No. 62/409,146, filed on Oct. 17, 2016.

(51) Int. Cl. A01K 1/015; A01K 1/035

(52) U.S. Cl. CPC A01K 1/0157; A01K 1/03; A01K 1/0353

(57) ABSTRACT

A dog kennel mat having a semi-rigid base, a bed, a plurality of raised shapes, walls with protruding sections, cushioned shapes attached to the raised shapes and the protruding sections, and gutters. More specifically, the semi-rigid base, bed, raised shapes, walls, and protruding sections can be formed from a single thermoformed elastomeric part, and the cushioned shapes can be made of closed cell foam. The dog kennel mat may be approximately rectangular in shape, having two long walls and two short walls, wherein one of the short walls can have an arched cutout.

### CROSS-REFERENCE TO RELATED APPLICATION

This application claims the benefit of U.S. Provisional Application No. 62/409,146 filed Oct. 17, 2016 and titled DOG KENNEL MAT.

### FIELD OF THE DISCLOSURE

This disclosure relates to a dog kennel mat for enabling dogs to dry quickly. More specifically, it relates to a removable dog kennel mat for insertion into a kennel, wherein the dog kennel mat has a semi-rigid base, a raised bed, and a plurality of raised shapes on the raised bed, wherein the raised bed and the raised shapes allow liquid and debris to pass through to the semi-rigid base.

### BACKGROUND OF THE INVENTION

Dog owners often buy dog mats or beds for their dogs to sit on when locked in a kennel. This provides additional comfort for the dog. However, these dog mats and beds are made with fabric, are often stuffed with soft material, and are typically not water-resistant. Therefore, they tend to acquire odor and are more subject to damage or destruction, whether by dog, moisture or overall environmental exposure. Additionally, these mats usually come in a predetermined size without regard to fit in specific kennel models. A well-fitted, water-resistant and durable dog kennel mat is needed that permits fast drying of dogs and mat materials.

### SUMMARY OF THE INVENTION

The present disclosure relates to a removable, water-resistant, durable dog kennel mat having a semi-rigid base, bed, and walls that are durable and resistant to chewing, scratching, fading, cracking, and water and other liquids. Additionally, the raised bed can include raised shapes and the walls can include protruding sections. The raised shapes and protruding sections may also be water-resistant and durable and may have a cushioned material adhered to their top surfaces that have padded qualities, are water-resistant, and can withstand chewing, scratching, fading, and cracking.

### BRIEF DESCRIPTION OF THE DRAWINGS

FIG. 1 is a top perspective view of a dog kennel mat according to one embodiment of the present disclosure.

FIG. 2 is a top perspective view of a dog kennel mat according to one embodiment of the present disclosure.

FIG. 3 is a top plan view of the dog kennel mat of FIG. 1.

FIG. 4 is a bottom plan view of the dog kennel mat of FIG. 1.

FIG. 5 is a top plan view of the dog kennel mat of FIG. 2.

FIG. 6 is a bottom plan view of the dog kennel mat of FIG. 2.

FIG. 7 is a back elevational view of a dog kennel mat according to one embodiment of the present disclosure.

FIG. 8 is a front elevational view of a dog kennel mat according to one embodiment of the present disclosure.

FIG. 9 is a cross-section view of a dog kennel mat according to one embodiment of the present disclosure.

FIG. 10 is a right side elevational view of a dog kennel mat according to one embodiment of the present disclosure; the left side elevational view is a mirror image of the right side elevational view.

FIG. 11 is a top plan view of a dog kennel mat according to one embodiment of the present disclosure.

FIG. 12 is a bottom plan view of the dog kennel mat of FIG. 11.

FIG. 13 is a back elevational view of the dog kennel mat of FIG. 11.

FIG. 14 is a front elevational view of the dog kennel mat of FIG. 11.

FIG. 15 is a left side elevational view of the dog kennel mat of FIG. 11.

FIG. 16 is a right side elevational view of the dog kennel mat of FIG. 11.

FIG. 17 is a cross-sectional front view of the dog kennel mat of FIG. 11 taken from the line 17-17 in FIG. 11.

FIG. 18 is a top, front right side perspective view of the dog kennel mat of FIG. 11.

FIG. 19 is a bottom, front left side perspective view of the dog kennel mat of FIG. 11.

### DETAILED DESCRIPTION

The present disclosure relates to a dog kennel mat that can be used as a removable insert in a dog kennel and that can enable the dog to stay dry and that permits faster, easier, and more hygienic drying of the dog and mat. Various embodiments of the dog kennel mat will be described in detail with reference to the drawings, wherein like reference numerals represent like parts and assemblies throughout the several views. Reference to various embodiments does not limit the scope of the dog kennel mat disclosed herein. Additionally, any examples set forth in this specification are not intended to be limiting and merely set forth some of the many possible embodiments for the dog kennel mat. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

Some embodiments of the dog kennel mat disclosed herein include features that facilitate removable insertion of the dog kennel mat into a kennel for a wet and/or dirty dog. However, the mat may be used for any kennel, regardless of the type of animal being crated. The physical properties of the dog kennel mat enable the mat to be resistant to scratches, tears, stains, water, and odor, all while allowing the dog to be comfortable while confined in the kennel.

More specifically, the dog kennel mat, in some embodiments, has a semi-rigid base 102 created from an elastomeric compound, such as, but not limited to, a thermoplastic elastomer (TPE), a bed 104 configured on top of the semi-rigid base 102, and cushioned shapes 116, such as closed cell foam, attached to the top of the bed 104. The dog kennel mat can have a single formed (such as thermoformed) or constructed part that includes the semi-rigid base 102 and the bed 104, and the cushioned shapes 116 (such as closed cell foam) can adhere to the bed 104. More specifically, the bed 104 can have raised shapes 106 such as, but not limited to, discs, linear rows, diagonal rows, or any other pattern or combination of patterns to which the cushioned shapes 116 (such as closed cell foam), having corresponding discs, linear rows, diagonal rows, or other pattern, can adhere. In some embodiments, the bed 104 has a raised body, which, in combination with the walls and base, defines a gutter 114 that surrounds the perimeter of the bed 104, and the raised shapes 106 lift up off of the raised body. In other embodiments, the bed 104 only has the raised shapes 106 and the body can be either concave or flat.

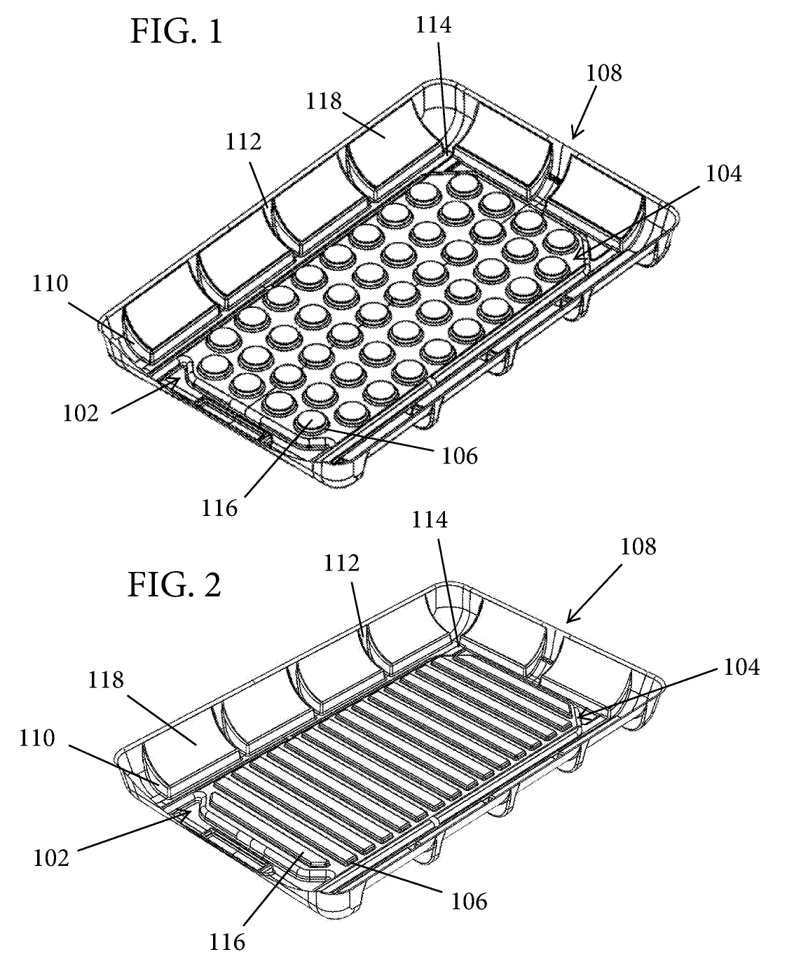

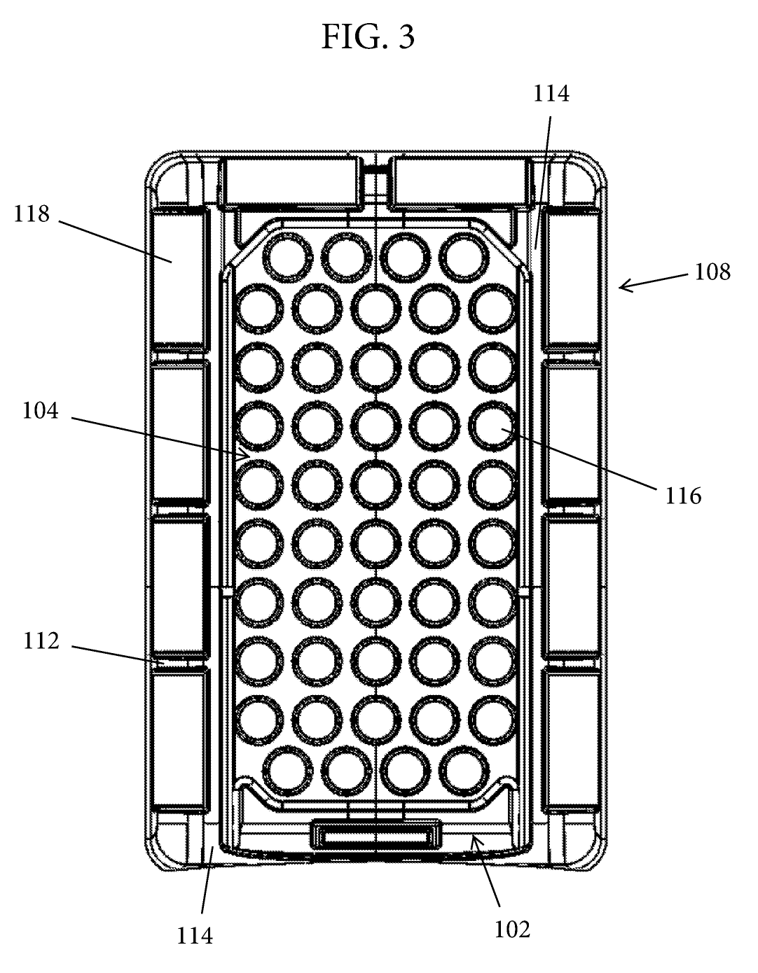

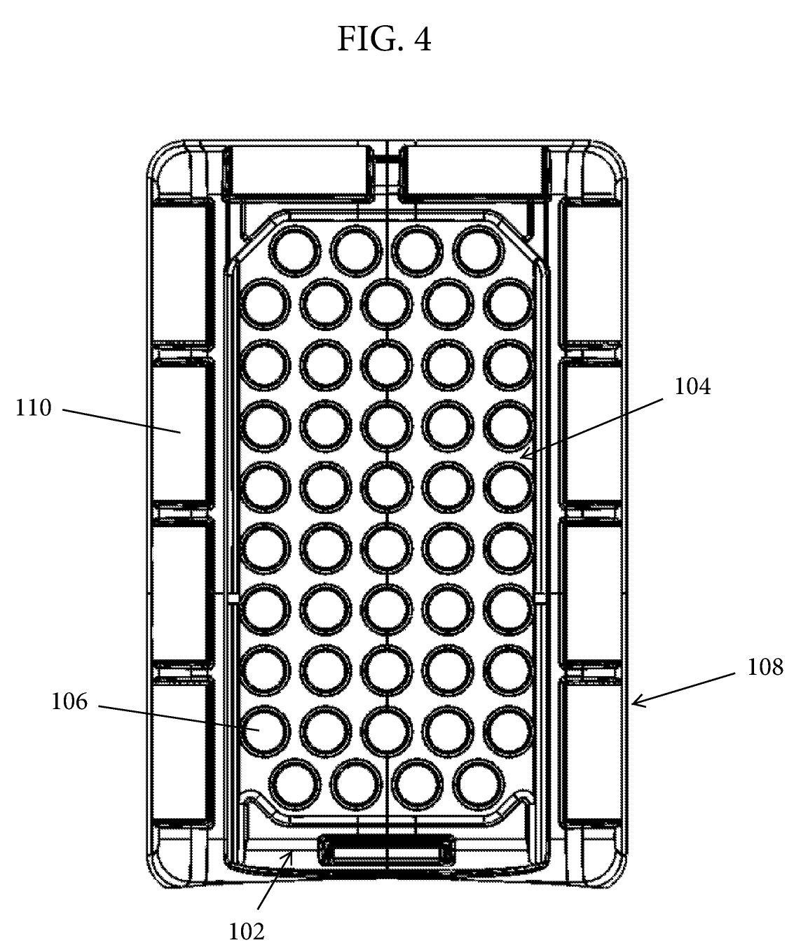

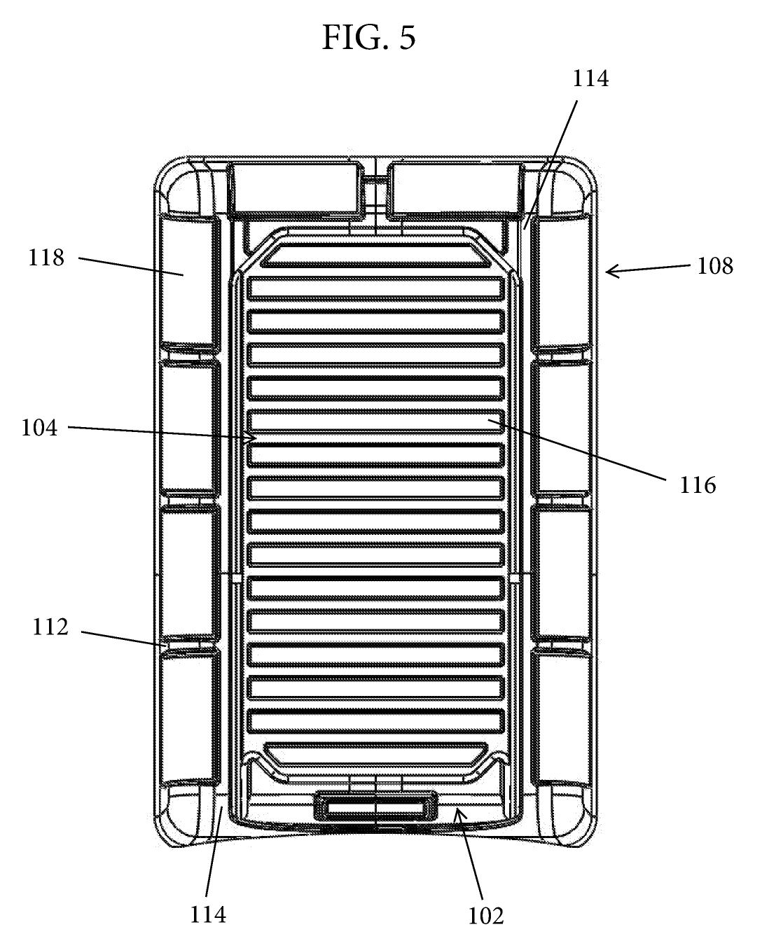

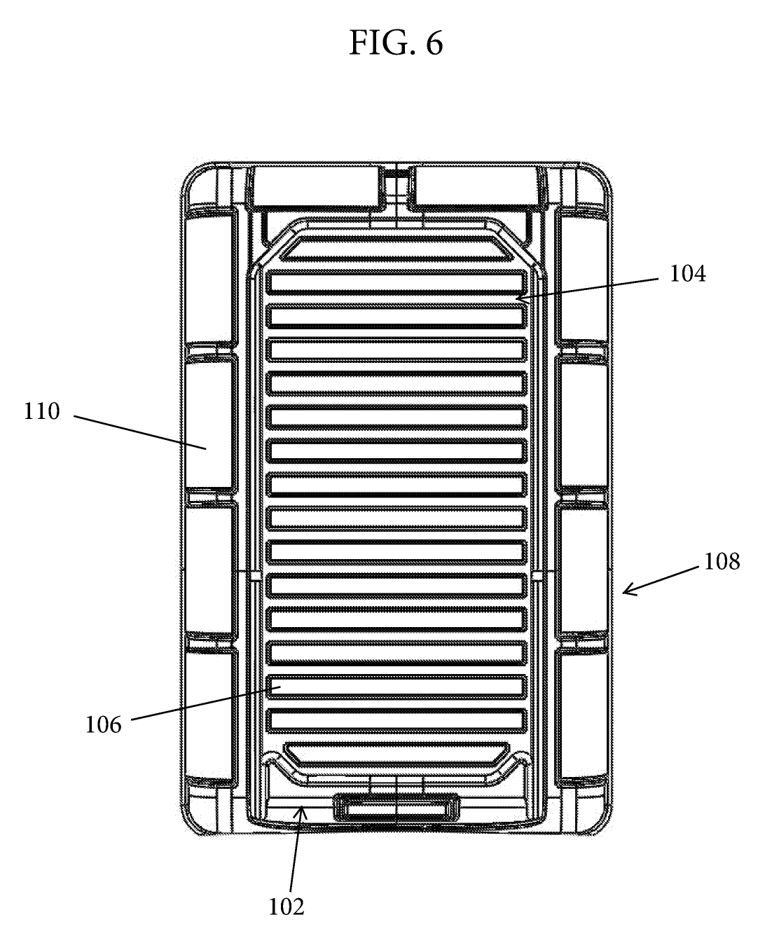

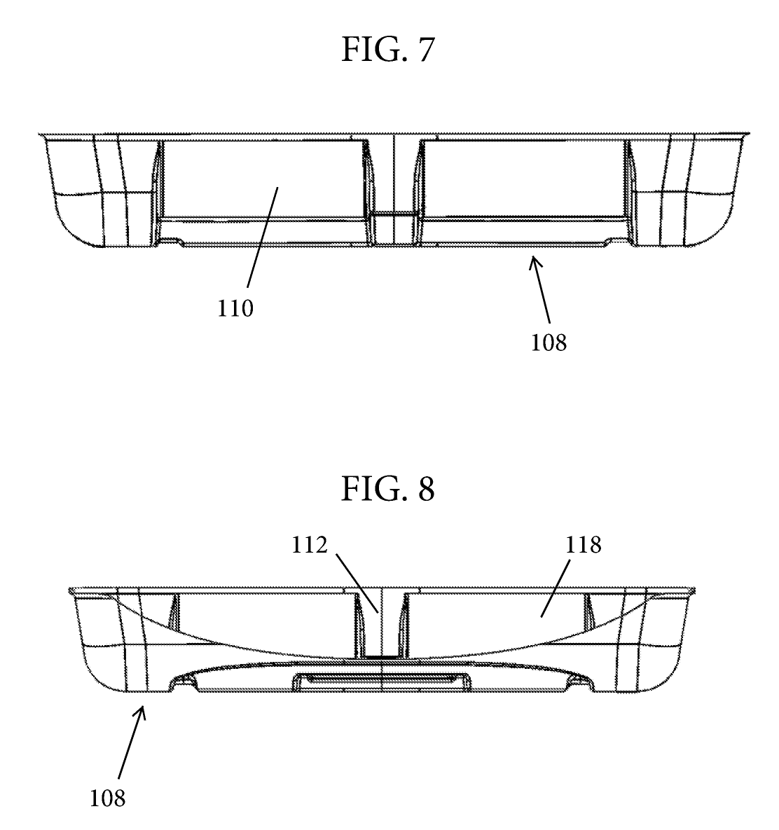

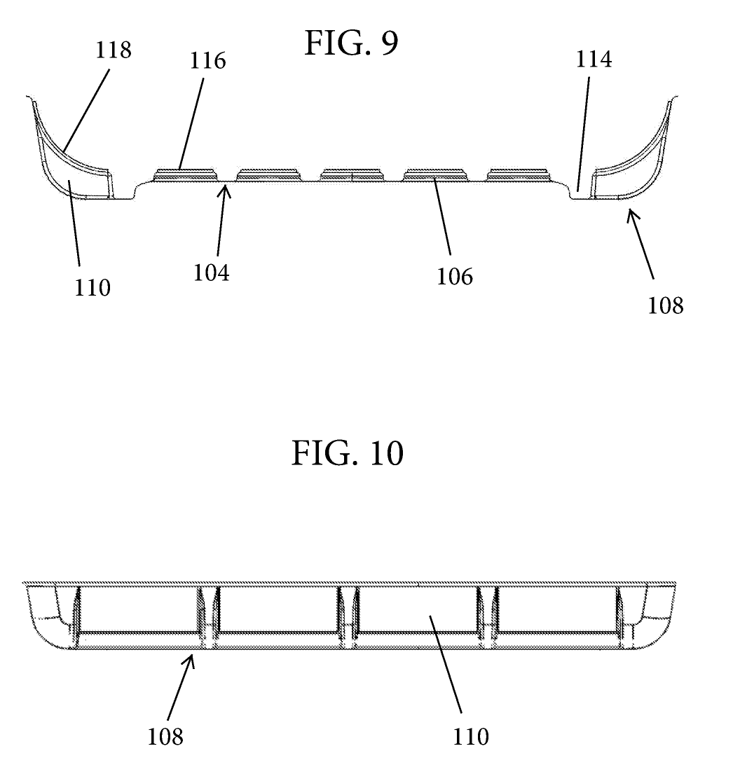

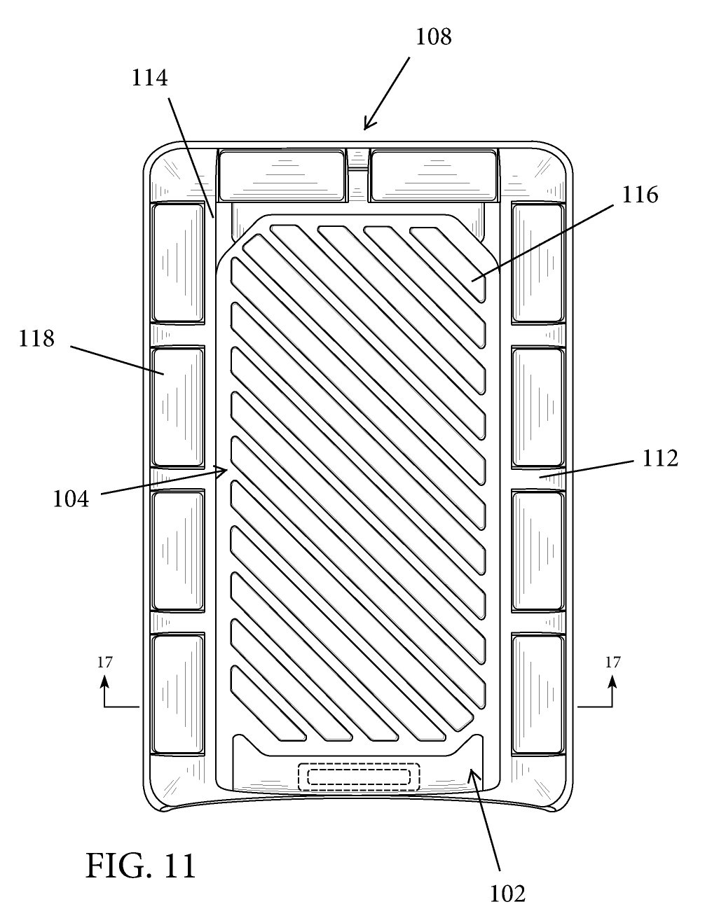

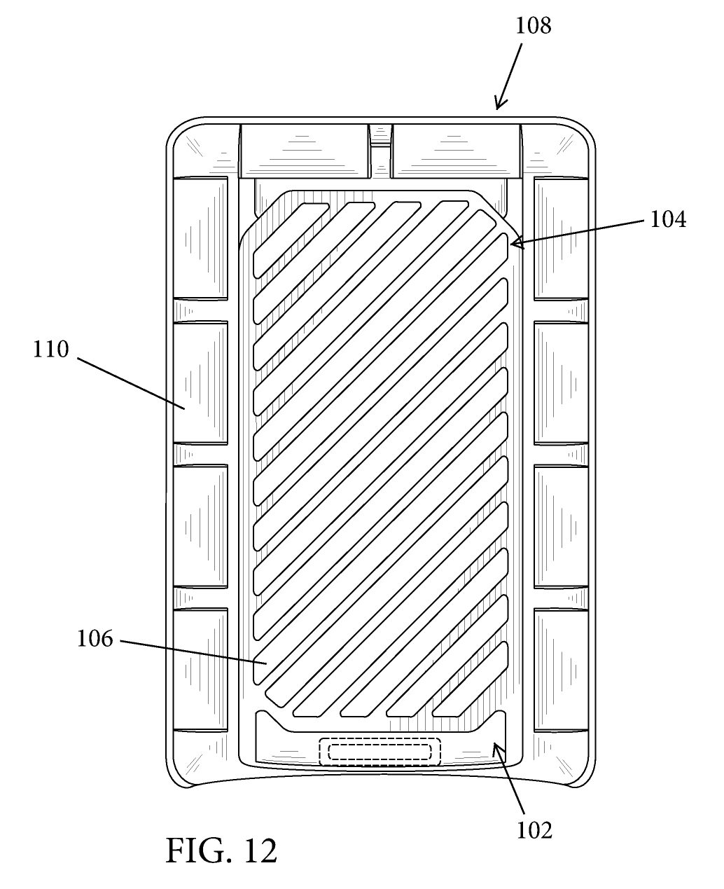

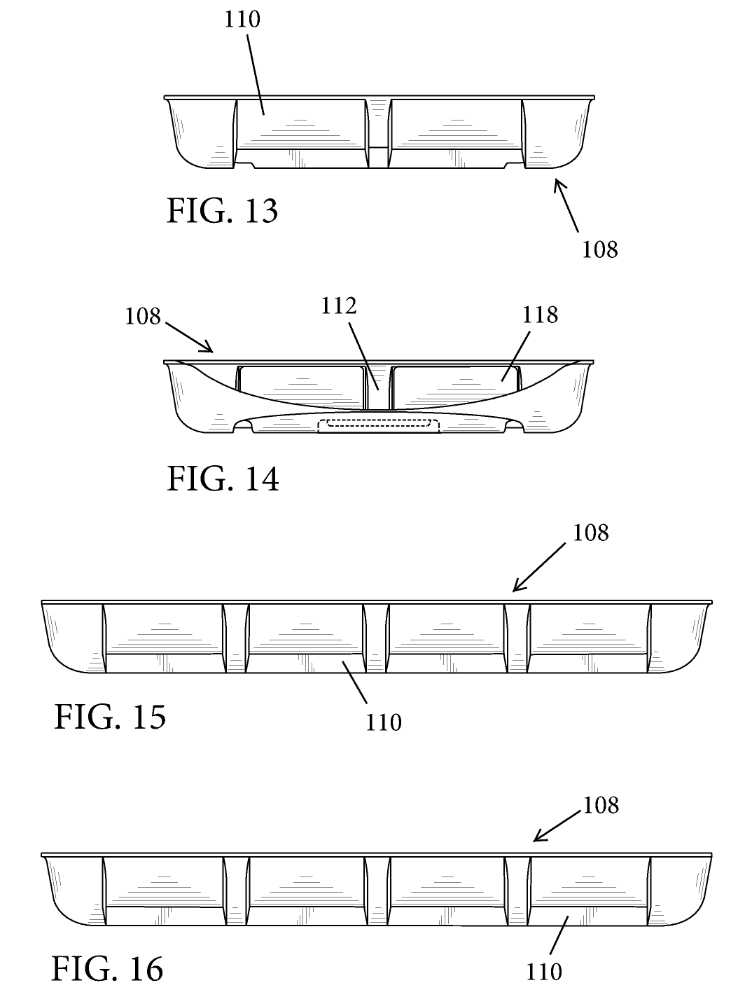

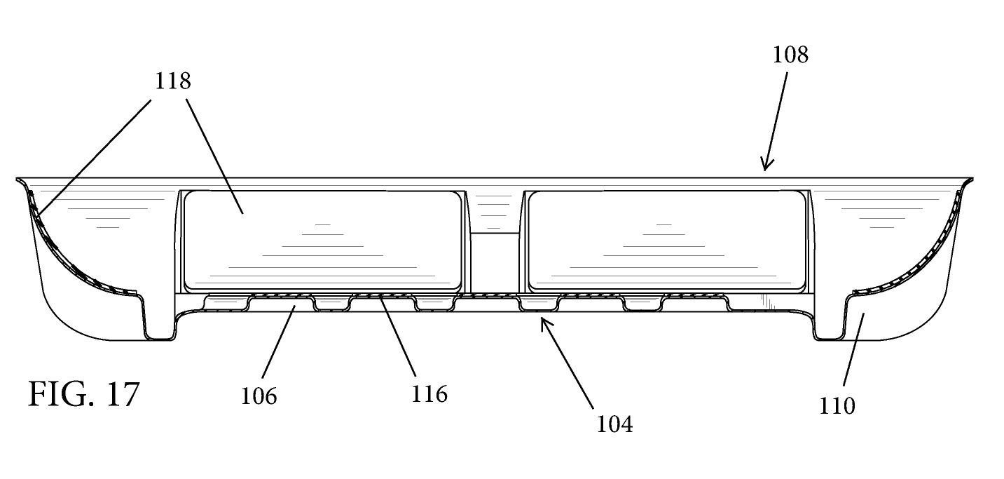

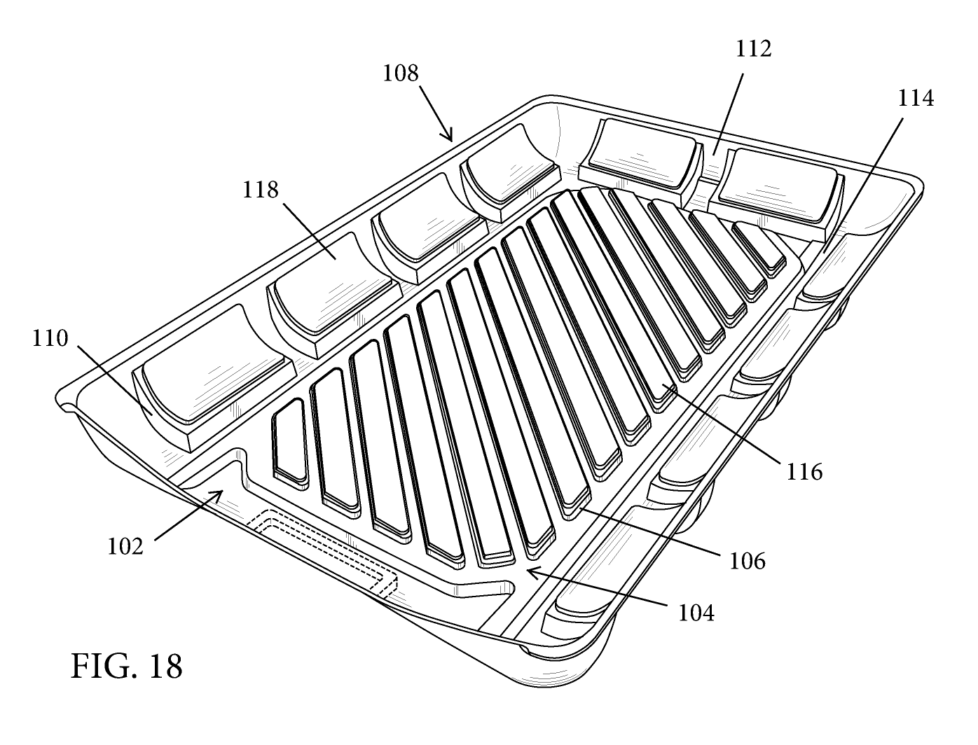

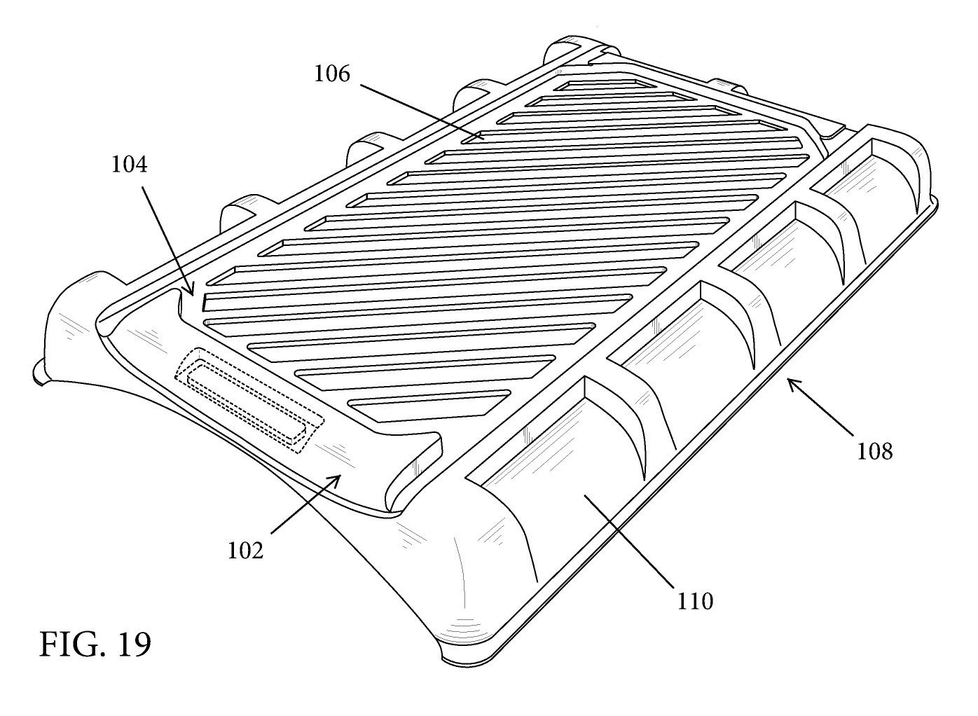

FIGS. 1-19 illustrate various views of example dog kennel mats according to the present disclosure. FIG. 1 is a top perspective view of a first embodiment. FIG. 2 is a top perspective view of a second embodiment. FIG. 3 is a top plan view of the first embodiment. FIG. 4 is a bottom plan view of the first embodiment. FIG. 5 is a top plan view of the second embodiment. FIG. 6 is a bottom plan view of the second embodiment. FIG. 7 is a back elevational view. FIG. 8 is a front elevational view. FIG. 9 is a cross-sectional view of the first embodiment. FIG. 10 is a right side elevational view. FIG. 11 is a top plan view of a third embodiment. FIG. 12 is a bottom plan view of the third embodiment. FIG. 13 is a back elevational view of the third embodiment. FIG. 14 is a front elevational view of the third embodiment. FIG. 15 is a left side elevational view of the third embodiment. FIG. 16 is a right side elevational view of the third embodiment. FIG. 17 is a front, cross-sectional view of the third embodiment. FIG. 18 is a top perspective view of the third embodiment. FIG. 19 is a bottom perspective view of the third embodiment.

Generally, as illustrated in FIGS. 1, 2, and 18, the dog kennel mat can be approximately rectangular in nature and has raised walls. However, the dog kennel mat can take any shape, such as, but not limited to, a square, quadrilateral, trapezoid, or other non-standard shape. In one embodiment, the dog kennel mat can be comprised of a semi-rigid base 102, a bed 104 having raised shapes 106 to which corresponding soft, cushioned shapes 116 can attach, walls 108 having protruding sections 110 separated by spaces or gaps 112, and gutters 114 along the circumference of the bed 104 and at the base of the protruding sections 110. The raised shapes 106 and the soft, cushioned shapes 116 can be, in one embodiment, a plurality of diagonal rows on the top of the bed 104. However, the raised shapes 106 and cushioned shapes 116 may take any shape such as, but not limited to, discs, linear rows, or any other pattern or combination of patterns as illustrated in FIGS. 1, 2, and 18. Additionally, as described above, the bed 104 may be raised, flat, or concave, determined primarily by the shape of the kennel floor, which the dog kennel mat accommodates.

The semi-rigid base 102, while rigid enough to hold its form, preferably has some elasticity and/or flexibility to it and can be made of any elastomeric material. For example, it can be made of or formed from silicone or a TPE. In one embodiment, the semi-rigid base 102 can be made of sheets of a TPE that are thermoformed and sized specifically to predetermined specifications. Additionally, the semi-rigid base 102 can be extremely durable and resistant to chewing, scratching, odors, water or other liquid, fading, and cracking while simultaneously maintaining its elastic characteristics.

In some embodiments, the semi-rigid base 102 can be approximately rectangular in shape and has a flat bottom. The top, or a central portion of the top, of the semi-rigid base 102 may be the bed 104 to which the cushioned shapes 116 can attach and, therefore, the bed 104 can have corresponding raised shapes 106 built into it. More specifically, the corresponding raised shapes 106 on the top of the bed 104 may be thermoformed into the semi-rigid base 102 to enable more efficient construction of the dog kennel mat. Therefore, the semi-rigid base 102, bed 104, and raised shapes 106 may all be one thermoformed, or other constructed, part.

The bed 104 can be preferably made of a water-resistant, flexible material. In some embodiments, the bed 104 can be made of the same material as the semi-rigid base 102. For example, the bed 104 can be made of silicone or a TPE. As mentioned above and illustrated in FIGS. 1-6, 9, 11-12, and 17-19, the bed 104 can be formed from the same mold or starting material as the semi-rigid base 102 and can have raised shapes 106 formed on its top. However, in some embodiments, the bed can be relatively flat and does not have raised shapes 106.

The raised shapes 106, as mentioned above, can be strips of similar or varying sizes (such as lengths, widths, or depths) that, when combined on the bed 104, create a repeating, diagonal pattern. Alternatively, the strips, when combined on the bed 104, can create straight rows, such as a repeating horizontal pattern or a vertical striped pattern. In another embodiment, the raised shapes 106 can be discs of similar or varying sizes (such as lengths, widths, or depths) that, when combined on the bed 104, create a repetitive or random pattern. Other shapes, or combinations of the disclosed or other shapes, are envisioned and can be located on the bed 104.

In some embodiments, cushioned shapes 116, 118 can attach to the raised shapes 106 on the bed 104 and to the protruding sections 110 on the walls 108. These cushioned shapes 116, 118 can be comprised of closed cell foam. More specifically, they can be made of sheets of closed cell foam, such as neoprene or ethylene-vinyl acetate (EVA), and can be shaped (such as via die-cutting) to match the designed raised shapes 106 that are on the bed 104. Additionally, they can be patterned or can have a patterned material attached to their surface. The raised shapes 106 and the cushioned shapes 116 may be comprised of matching shapes such as, but not limited to, a plurality of discs, linear rows, diagonal rows, or other shapes or combinations of shapes, as described above. The protruding sections 110 and the cushioned shapes 118 may also be comprised of matching shapes. In one embodiment, the cushioned shapes 116, 118 may be removable from the raised shapes 106 on the bed 104 and on the protruding sections 110 to enable a user to replace one or more cushioned shapes 116, 118, which is beneficial if the cushioned shapes 116, 118 need to be cleaned and/or replaced.

In preferred embodiments, the raised shapes 106 and protruding sections 110, having cushioned shapes 116, 118 attached to them that can be made of foam, create a comfortable, padded space for a dog to rest on. Additionally, the cushioned shapes 116, 118 can further elevate the dog off of the semi-rigid base 102 and the bed 104 and keep the dog separated from the walls 108. This configuration allows liquid and other debris to pass through the spaces between the cushioned shapes 116, 118. Therefore, the raised shapes 106 and protruding sections 110 can enable air to flow beneath and around a dog for quick drying, and it can help keep the dog cool. In embodiments where the bed 104 is a separate piece from the semi-rigid base 102, the bed 104 can also be durable and resistant to water or other liquid, odor, scratching, chewing, cracking, and fading.

In some embodiments, the raised shapes 106 and protruding sections 110 can have raised lips (not illustrated), which the cushioned shapes 116, 118 can nest within, which helps prevent the cushioned shapes 116, 118 from being easily chewed on or ripped off. The raised lips can have a comparable or shorter height than the cushioned shapes 116, 118 and can be an extension upward of the raised shapes 106 and protruding sections 110. Additionally, the raised lips can be made of the same material as the raised shapes 106 and protruding sections 110.

As described above, the dog kennel mat can be rectangular and, therefore, may have four walls 108. However, the dog kennel mat can take any shape and can have a correspondingly appropriate number of walls 108. The walls 108 can have a uniform thickness and can protrude out from the semi-rigid base 102 at a variety of angles. For example, the walls 108 may be 90-degree vertical walls, or they may be slanted outward at angles greater than 90 degrees. In some embodiments, as illustrated in FIGS. 1-6, 11-12, and 18-19, the corners of the walls 108 may be rounded to prevent injury to a dog or a person responsible for putting the dog in a kennel. The walls 108 can be made of any rigid or semi-rigid material. For example, they can be made of the same material as the semi-rigid base (such as any elastomeric material) and can also have durable and water-resistant properties. Therefore, the walls 108, similar to the bed 104 and raised shapes 106, may be formed or constructed out of the same piece of material as the semi-rigid base 102. However, the walls 108 may be separate pieces.

In some embodiments, all of the walls 108 are uniform in height. However, in other embodiments, one or more of the walls 108 have different heights. For example, the dog kennel mat, if rectangular in shape, can have two long side walls and a back wall that are uniform in height, as illustrated in FIGS. 7, 10, 13, and 15-16, and a front wall that can be variable in height. More specifically, as illustrated in FIGS. 8 and 14, the front wall may have an arched cutout so that, near the corners, the front wall may be the same height as the other walls, but it arcs downward creating an arched opening with the center of the front wall being the lowest point of the front wall. This shape enables a dog to move easily onto and off of the dog kennel mat. In another embodiment, both the front and the back wall have this arched cutout.

As illustrated in FIGS. 1-2, 9, and 7-19, the protruding sections 110 can be on the inside of the walls 108 and can protrude from the walls 108 toward the interior space of the dog kennel mat that the dog will occupy. The sections 110 can be similar to the raised shapes 106 and can be made of the same material as the semi-rigid base 102 and the bed 104. Further, the sections 110 can have cushioned shapes 118 (such as foam) attached to their surfaces, can have durable and water-resistant properties, and can be uniform in thickness or can vary in thickness and size. For example, as illustrated in FIGS. 1, 2, and 18-19, the protruding sections 110 may be thinnest at their top ends near the top of the wall 108, may generally slope down toward the interior space of the dog kennel mat, may thicken as the protruding section slopes downward toward the interior space of the dog kennel mat, and may end at a relatively flat bottom end that faces the bed 104, raised shapes 106 of the bed, and cushioned shapes 116 of the raised shapes 106. More specifically, the bottom surface of each section 110 may have a steeper slope than the top surface of each section 110, thereby creating a sloped section 110 having space between its top surface and bottom surface. Additionally, while the top end of the sloped section 110 can be narrow and/or pointed, the bottom end of the sloped section 110 can have a flat face that connects on a first edge to the top surface and on a second edge to the bottom surface, as illustrated in FIGS. 1, 2, and 18-19. This flat face makes for a more comfortable surface for a dog to lie against.

The protruding sections 110 may be located on every wall 108, may be on some but not all of the walls 108, or may be located on only one wall 108. Additionally, the protruding sections 110 can cover a portion of or all of each wall 108. While the protruding sections 110 can be a similar height to the walls 108 (and can be the same or similar height when taking into account the attached, cushioned shapes 118), the protruding sections 110 may have any height and/or any length. This enables a section 110 to cover the entire length and/or height of a wall 108 or a portion of the length and/or height of the wall 108.

In one embodiment, the dog kennel mat can be rectangular, has four protruding sections 110 on each of its two long walls, two protruding sections 110 on its back wall, and, due to the arched cutout of the front wall, no protruding section 110 on its front wall. Alternatively, both short walls (such as the front wall and the back wall) may have two protruding sections 110. In some embodiments, all of the protruding sections 110 are uniform in size. In other embodiments, the protruding sections may vary in size. For example, the front wall may have smaller, protruding sections 110 than the protruding sections 110 on the other walls with one of each of the smaller protruding sections 110 on either side of the arched cutout. However, if the front wall does not have an arched cutout, the dog kennel mat may have two protruding sections 110 on its front wall that are similar in size to the protruding sections 110 on the back wall.

In embodiments wherein a wall 108 includes a plurality of protruding sections 110, there can be spaces or gaps 112 in between each of the protruding sections 110. For protruding sections 110 on a first wall that end near a second wall having no protruding sections 110, there can be a space or gap 112 between the second wall and the final protruding section 110 on the first wall in addition to the spaces or gaps 112 between all of the protruding sections 110. These spaces or gaps 112 can collect liquid and debris that falls off of the dog while the dog is on the mat due to the space created between the dog and the walls 108 by the protruding sections 110.

In addition to the spaces or gaps 112, in some embodiments, the dog kennel mat, as described above, has gutters 114 that also collect liquid and debris. The gutters 114 can be located along the circumference of the bed 104 and the flat face of the bottom end of the protruding sections 110. In some embodiments, the spaces or gaps 112 connect to the gutters 114 so that any liquid or debris that falls into the spaces or gaps 112 can transfer into the gutters 114, or vice versa. In one embodiment, the spaces between the raised shapes 106 and/or cushioned shapes 116 can be raised slightly higher than the spaces or gaps 112 and gutters 114, as illustrated in FIGS. 9 and 17. However, because the spaces between the raised shapes 106 and/or cushioned shapes 116 extend to the edge of the bed 104, any liquid or debris that falls into those spaces can transfer into the spaces or gaps 112 and the gutters 114.

In some embodiments, the dog kennel mat can be one removable piece that can be placed into and taken out of a dog kennel. In other embodiments, two or more of the individual components of the dog kennel mat are removable from each other to make for easier cleaning and/or replacement of parts. For example, the bed 104 may be separable from the semi-rigid base 102, the raised shapes 106 may be separable from the bed 104, the cushioned shapes 116, 118 may be separable from the raised shapes 106 and/or protruding sections 110, the walls 108 may be removable, the protruding wall sections 110 may be removable, or any of the above in combination may be possible.

In embodiments where the bed 104 is separable from the semi-rigid base 102, various ways of attaching the bed 104 to the semi-rigid base 102 may exist. For example, the bed 104 may rest on top of the semi-rigid base 102, the raised shapes 106 may align on the bed 104 with corresponding shapes on the top of the semi-rigid base 102, or the bed 104 and raised shapes 106 may be one piece that can attach to the semi-rigid base 102 along its edges. In the example of the bed 104 and raised shapes 106 attaching to the semi-rigid base 102 along its edges, the attachment may take place through, for example, the use of hook and loop fasteners, snaps, buttons, slots and corresponding protrusions, or a rails system.

In embodiments where the walls 108 are removable, the walls 108 may attach to the semi-rigid base 102 and each other through the use of, for example, hook and loop fasteners, snaps, buttons, slots and corresponding protrusions, or a rail system. In embodiments where the protruding wall sections 110 are removable, the protruding wall sections 110 may attach to the walls 108 through the use of, for example, hook and loop fasteners, adhesive, snaps, slots and corresponding protrusions, or a rail system.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A dog kennel mat comprising:
a semi-rigid base;
four walls, including a front wall, a back wall, and two side walls, the back wall and the two side walls each including a plurality of protruding sections separated by gaps; and
a bed comprising a plurality of raised shapes;
wherein the base, walls, and bed of the dog kennel mat are configured to define a gutter about a circumference of the bed.

2. The dog kennel mat of claim 1, further comprising a first plurality of cushioned shapes attached to the raised shapes, wherein the raised shapes and the first plurality of cushioned shapes include a plurality of strips forming diagonal rows.

3. The dog kennel mat of claim 1, further comprising a first plurality of cushioned shapes attached to the raised shapes, wherein the raised shapes and the first plurality of cushioned shapes include a plurality of strips forming horizontal rows.

4. The dog kennel mat of claim 1, further comprising a first plurality of cushioned shapes attached to the raised shapes, wherein the raised shapes and the first plurality of cushioned shapes include a plurality of strips forming vertical rows.

5. The dog kennel mat of claim 1, further comprising a first plurality of cushioned shapes attached to the raised shapes, wherein the raised shapes and the first plurality of cushioned shapes include discs.

6. The dog kennel mat of claim 1, wherein the semi-rigid base includes an elastomeric compound.

7. The dog kennel mat of claim 6, wherein the elastomeric compound is a thermoplastic elastomer.

8. The dog kennel mat of claim 1, further comprising a first plurality of cushioned shapes attached to the raised shapes and a second plurality of cushioned shapes attached to the protruding sections of the back wall and side walls.

9. The dog kennel mat of claim 8, wherein the first and second pluralities of cushioned shapes include closed cell foam.

10. The dog kennel mat of claim 9, wherein the first and second pluralities of cushioned shapes are removable.

11. The dog kennel mat of claim 1, wherein the semi-rigid base, the bed, the raised shapes, the front wall, the back wall, the two side walls, and the plurality of protruding sections are formed from a single thermoformed part.

12. The dog kennel mat of claim 1, wherein the bed includes a raised body and the gutter is located about the circumference of the raised body of the bed.

13. The dog kennel mat of claim 1, wherein the front wall has an arched cutout.

14. The dog kennel mat of claim 1, wherein the two side walls each have at least four protruding sections and the back wall has at least two protruding sections.

15. The dog kennel mat of claim 14, wherein the protruding sections are uniform in size and shape.

16. The dog kennel mat of claim 14, wherein the front wall has at least two protruding sections.

17. The dog kennel mat of claim 16, wherein the protruding sections are uniform in size and shape.

18. The dog kennel mat of claim 1, wherein each of the protruding sections:
protrude from an inside face of the back wall or one of the two side walls toward an interior space of the dog kennel mat;
have a top surface and a bottom surface, wherein the top surface and the bottom surface each have a slope that slopes downward toward the interior space of the dog kennel mat and the slope of the bottom surface is steeper than the slope of the top surface;
have a top end near a top of the walls that is thinner than any other part of the protruding section; and
have a flat face that connects on a first edge to the top surface and on a second edge to the bottom surface.

19. The dog kennel mat of claim 1, wherein the front wall, the back wall, and the two side walls are removable.

20. The dog kennel mat of claim 1, wherein the front wall, the back wall, and the two side walls are slanted outward at angles greater than 90 degrees.
